(19) United States
(12) Patent Application Publication
(10) Pub. No.: US 2008/0181746 A1
(43) Pub. Date: Jul. 31, 2008

(54) Fastener for anchoring in solid bases

(75) Inventor: Stefan Reiter, Nendeln (LI)

Correspondence Address: BUCHANAN, INGERSOLL & ROONEY PC, POST OFFICE BOX 1404, ALEXANDRIA, VA, 22313-1404, US

(73) Assignee: Pama Reiter Stefan, Nendeln (LI)

(21) Appl. No.: 12/010,193

(22) Filed: Jan. 22, 2008

Related U.S. Application Data
(63) Continuation of application No. PCT/CH2006/000377, filed on Jul. 19, 2006.

(30) Foreign Application Priority Data
Jul. 21, 2005 (CH) 01217/05

(51) Int. Cl. F16B 37/04

(52) U.S. Cl. 411/177

(57) ABSTRACT

A fixing element is disclosed for anchoring in solid massive bases, such as, for example, concrete, stone, solid brick, wood or similar which includes a tie bolt provided with an anchoring section having a spiral-shaped surrounding profile at least over a partial area of the longitudinal extension. A head section, which expands in the radial direction in relation to the anchoring section, connects to the anchoring section counter to the direction of mounting. The fixing element also includes a helical spring which can be premounted on the partial area of the anchoring section which is provided with the spiral-shaped profile. The spiral-shaped surrounding profile is formed from at least two axial cone sections which adjoin one another and which have a cover surface which extends in a spiral-shaped manner, the surface widening in the direction of mounting. The cone sections include a pitch which is greater than a pitch of the helical spring. The front end of the helical spring is supported upon a front end area of a front cone section.

### RELATED APPLICATIONS

This application claims priority under 35 U.S.C. §119 to Swiss Patent Application No. 01217/05 filed in Switzerland on Jul. 21, 2005, and as a continuation application under 35 U.S.C. §120 to PCT/CH2006/000377 filed as an International Application on Jul. 19, 2006, designating the U.S., the entire contents of which are hereby incorporated by reference in their entireties.

### TECHNICAL FIELD

A fastener is disclosed for anchoring in solid bases, such as for example, concrete, stone, solid brick, or wood.

### BACKGROUND INFORMATION

For anchoring in a light load range in solid bases, such as for example concrete, stone, solid brick, wood or the like, various fastening techniques and fasteners are known. A known fastener is the classic expansion anchor which generally consists of plastic and which is inserted into a prepared receiving hole. To attach a component, a screw is inserted through the component and screwed into the anchor. The attainable load values for plastic anchors are limited. In case of fire they are not safe. They are not suited for tensile zones and do not have any afterexpansion. The axial and edge distances to be maintained are relatively large. The preparation of the fastening, depending on whether it is a plastic or metal anchor, is relatively complicated, by a screw having to be screwed into the anchor which has been inserted into the receiving hole. The anchor diameter and thus the diameter of the receiving hole to be prepared are much larger than the connection diameter of the screw which is to be screwed in.

Fasteners are known which are hammered into a prepared receiving hole. DE-A41 13 381 discloses a fastener which includes a screw which is provided with a head section and which has an anchoring section with an outside thread. The anchoring section in the threaded region has an outside diameter which widens opposite the setting direction. A helical spring-like spiral is dimensioned such that in the mounted state it engages the threads of the screw and in the section of the threaded region which is backwards on the setting side projects radially over the largest outside diameter of the anchoring region. A flattened anchoring tab extends from the end of the spiral which is the backward end on the setting side in the direction of the head section and is intended to ensure additional fixing of the spiral in the receiving hole when the fastener is driven by striking it. The load values of this known fastener are not overly high, since only those regions of the spiral contribute to anchoring which in the mounted state project over the outside diameter of the anchoring region. The flattened anchoring tab can be obstructive after removal when the screw is replaced, since there is the danger that the vertically projecting end of the spiral which has remained in the receiving hole will interlock in the screw thread. The fastener does not have any afterexpansion and therefore is not suited for a tensile zone.

### SUMMARY

A fastener is disclosed for anchoring in a solid base, such as for example concrete, stone, solid brick, wood or the like, which can have high load values in a light load range. The fastener can be suited for a tensile zone and can have afterexpansion properties. It can be easy to place; for example, it can be installed by striking it, and can be removed again; mounting by passing it through and by pinning is also possible. Special tools are not necessary for installation. The fastener can acquire a certain pretension by impact installation; this pretensioning can provide for preattachment of an installed component.

In an exemplary embodiment, a fastener for anchoring in solid bases is disclosed, such as for example concrete, stone, solid brick, wood or the like, comprising an anchor bolt with an anchoring section which is provided with profiling which runs peripherally in a coil-like manner over a partial region of its lengthwise extension, a head section which adjoins the anchoring section opposite a setting direction and which has been radially expanded relative to the anchoring section, and a helical spring which can be premounted on the partial region of the anchoring section, wherein the profiling which runs peripherally in the coil-like manner is formed by at least two axially adjoining cone sections with a jacket surface which runs in a coil shape, which sections widen in the setting direction of the anchor bolt, the cone sections having a pitch which is greater than a pitch of the helical spring, and a front end of the helical spring on the setting side being supported on a front end region of the cone section which is exposed on the setting side of the anchor bolt.

### BRIEF DESCRIPTION OF THE DRAWINGS

Other advantages and features will become apparent from the following description of exemplary embodiments of the disclosure with reference to the schematics. The figures are not to scale.

FIG. 1 shows a first exemplary embodiment of the fastener disclosed herein;

FIG. 2 shows individual components of the fastener as shown in FIG. 1;

FIG. 3 shows an exemplary version of the fastener inserted in a receiving hole;

FIG. 4 shows the fastener from FIG. 4 with an anchor bolt which has been screwed out of the receiving hole;

FIGS. 5 to 7 show three exemplary embodiments of the fastener with head sections made differently;

FIG. 8 shows the tip section of another exemplary embodiment of the fastener, which section is the front one on the setting side; and

FIGS. 9a-d show four cross sectional versions of a spring wire for a helical spring.

### DETAILED DESCRIPTION

A fastener is disclosed for anchoring in solid bases, such as for example concrete, stone, solid brick, wood or the like which has an anchor bolt with an anchoring section which is provided with profiling which runs peripherally in a coil-like manner over a partial region of its lengthwise extension. A head section which had been radially expanded relative to the anchoring section adjoins the anchoring section opposite the setting direction. The fastener also comprises a helical spring which can be premounted on the partial region of the anchoring section provided with the coil-like profiling. The profiling which runs peripherally in the coil-like manner is formed by at least two axially adjoining cone sections with a jacket surface which runs in a coil shape, which sections widen in a setting direction. The cone sections have a pitch which is greater than a pitch of the helical spring. The end of the helical spring which is a front end on the setting side is supported on a front end region of the cone section which is frontmost on the setting side.

This helical spring is drawn in length in hammered installation of the fastener, especially by the different pitches of the coil-like profiling in the form of at least two cone sections and the helical spring; this results in increased pitch of the helical spring. The pitch of the cone sections is defined by the distance of the cone sections from one another and from two identical points of two adjacent cone sections, which points lie axially over one another. The pitch of the helical spring is defined by the distance of adjacent threads. Due to the stretching of the helical spring in hammered installation, the helical spring projects over the outside diameter of the anchoring section (e.g., essentially over its entire length) and leads to positive and nonpositive anchoring of the fastener in the receiving hole. The support of the helical spring in the end region which is frontmost on the setting side ensures its stretching in hammered installation. Stretching loads the spring in tension and in the set state the spring tends to return again to the initial state. In this way the fastener experiences a certain pretensioning which leads to preattachment of a fastened component. To adjust the component, the anchor bolt can be screwed slightly out of the helical spring and afterwards tightened to the desired degree. When loaded in tension, the helical spring is further spread due to the cone sections which expand in the setting direction. This leads to an increase of the holding values of the fastener which has been placed in the receiving hole. In a receiving hole which is opening, this effect causes afterexpansion. In this way the fastener can also be used in a tensile zone. The pitches of the cone sections and of the jacket surface as well as of the helical spring which differ from one another can also ensure that a helical spring, once installed, is not lost.

Anchoring can take place uniformly over the entire length of the anchoring section which is provided with coil-like profiling. In this way anchoring with relatively low axial and edge distances is enabled. Installation takes place very simply by hammering the fasteners in. The anchor bolt is simply unscrewed again from the hole for removal. The helical spring slides along the coil-shaped jacket surface of the cone sections and remains in the receiving hole. The fastener can thus be removed flush with the surface. For re-attachment the anchor bolt is simply again placed on the receiving hole and screwed into the helical spring with its anchoring section which is provided with coil-like profiling. To facilitate the process of screwing it in, there can be chamfering of the region of the front cone section which is frontmost on the setting side. Due to the high holding values which can be achieved with the disclosed fastener, the anchoring region of the anchor bolt can be made with a relatively small outside diameter. This can have an advantage that the receiving hole can also be correspondingly small.

The end of the helical spring which is the front end on the setting side can be fixed by looping of the helical spring in the tapering anchoring section. In a version which is especially simple in terms of construction and production engineering with a front cone section which is provided with a flat face surface, the front end of the helical spring can be supported simply on the face surface. For this purpose the end of the helical spring which is the front end on the setting side is accordingly kinked or bent in.

The axial length of the anchoring section provided with the cone sections can be greater than the axial height of the helical spring in the relieved or in the premounted state.

For simple installation and in order to ensure the pretensioning effect, the region of the cone sections which has the smallest outside diameter and the material thickness of the helical spring can be made such that the sum of the smallest outside diameter and of the material thickness is equal to or slightly greater than the largest outside diameter of the cone sections.

To achieve good holding values, it is advantageous if the jacket surface of the cone sections which runs in a coil shape runs tilted by an angle from, for example, approximately 5° to 16°, preferably roughly 7° to roughly 14°, relative to the axis of the anchoring section.

One version of the fastener calls for the angle which is enclosed by the jacket surface of each cone section with the axis of the anchoring section to increase opposite the setting direction. The increase in the angle can take place in steps, for example in three steps. The angle can however also be increased continuously against the setting direction. This measure can further improve the afterexpansion behavior of the fastener.

To provide increased safety against fire and in order to guarantee resistance to corrosion, the anchor bolt and the helical spring can be made of metal, preferably of stainless steel.

In one version of the fastener, the head section has the shape of a hexagon. This can enable simple tightening or loosening of the fastener with an open-end or ring wrench of the corresponding size.

In another version of the fastener it can be provided that opposite the setting direction the hexagonal head is adjoined by a bolt section with a connecting thread. This version enables not only fixing of a component on the base, but also connection of other components via a screw connection. The fastener can also be anchored in the base and a component can be fastened to the projecting threaded bolt. The threaded bolt projecting from the head section has a much larger connection diameter than the anchoring section of the anchor bolt.

In another version of the fastener, the head section has the shape of a countersunk head or a lens head which is provided with application means for transmission of torque. The application means for transmission of torque can be made as a hexagon socket, a torx receiver or crossed slot receiver, a diagonally running slot or the like. Tightening or loosening of the fastener can take place with the correspondingly made tools.

So that the pretensioning of the fastener which has been hammered into the receiving hole is ensured for all solid bases, on the transition from the anchoring section to a head section with a larger outside diameter there can be an axially elastic liner part, for example a lock washer, a conical spring washer or the like.

The exact number of cone sections which are arranged axially in succession is dependent on the diameter of the fastener in the anchoring region, on the required setting depth and on the required holding values.

The helical spring can be wound from a spring steel wire. The wire can have a circular or oval cross section. In another version of the disclosure the wire can be a profile wire with a nonround cross section. The spring wire with the nonround cross section buries itself better into the wall of the hole.

In another version the wire of the helical spring can also be provided with a friction-reducing coating. The coating facilitates axial stretching of the helical spring when the fastener is installed by impact and promotes the afterexpansion behavior of the fastener.

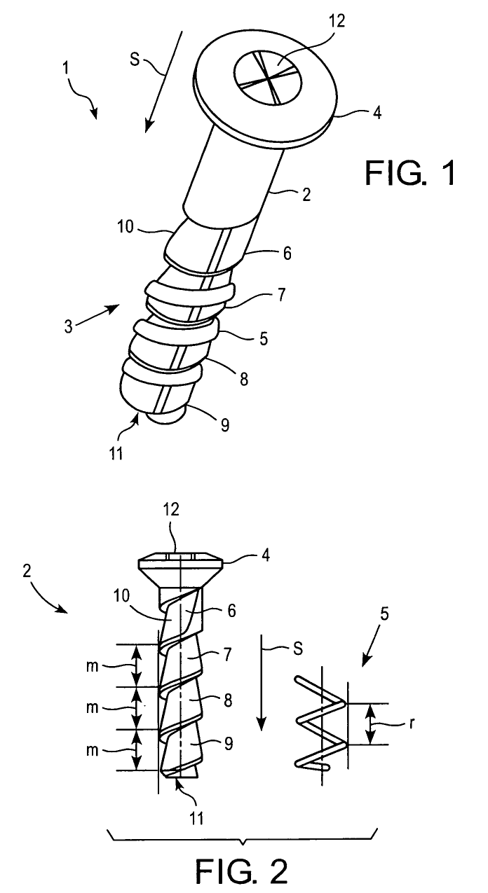

A first exemplary embodiment of the fastener which is shown in FIGS. 1 and 2 is labelled overall with reference number 1. It comprises an anchor bolt 2 with an anchoring section 3 and a head section 4 as well as a helical spring 5. The anchoring section 3 is provided with profiling which is formed by cone sections 6, 7, 8 and 9 which are located axially in succession and which widen in outside diameter in the setting direction which is indicated with the arrow S. The cone sections 6-9 have a jacket surface 10 which runs in the shape of a coil and which extends over the entire anchoring section 3. The jacket surface 10 which runs in the shape of a coil is tilted relative to the axis of the anchoring section 3 by an angle of, for example, 5° to 10°, preferably roughly 6° to roughly 8°, quite especially preferably roughly 7°. The helical spring 5 is mounted on the anchoring section 3 (FIG. 1) and is supported on the front end region of the cone section 9 which is frontmost on the setting side.

According to the illustrated embodiment, the helical spring 5 is supported on the front face surface 11 of the cone section 9 which is frontmost on the setting side. The cone sections 6-9 have a pitch m which is greater than the pitch r of the helical spring 5. The pitch of the cone sections is defined by the distance of the cone sections from one another and from two identical points of two adjacent cone sections, which points lie axially over one another. The pitch of the helical spring is defined by the distance of adjacent threads. The pitches of the cone sections and of the helical spring which differ from one another can ensure that the helical spring 5, once mounted, is not lost.

The material thickness of the helical spring 5 can be made such that the sum of the smallest outside diameter of the cone sections 6-9 and the material thickness is equal to or slightly greater than the largest outside diameter of the cone sections 6-9. The anchoring section has at least two cone sections. The illustrated embodiment has four cone sections 6-9 which are located axially behind one another. The number of possible cone sections depends on, for example, the total length of the anchoring section, on the maximum outside diameter of the anchoring section and on a desired minimum holding value of the fastener, by which the minimum diameter of the cone sections is established. The axial length of the anchoring section 3 which is provided with cone sections is greater than the axial height of the helical springs 5 in a relieved or in a premounted state.

The head section 4 of greater diameter can be made as a lens head which is widened in the manner of a flange, and has an inside application means 12 for transmission of torque. For example, the application means 12 can be made as hexagonal socket, a torx receiver or crossed slot receiver. In another version the application means for transmission of torque can also be made simply as a diagonally running slot or the like. The anchor bolt 2 is made of metal, such as a stainless steel. The helical spring 5 can include (e.g., consists of) a spring steel wire. It can also be provided with a friction-reducing coating.

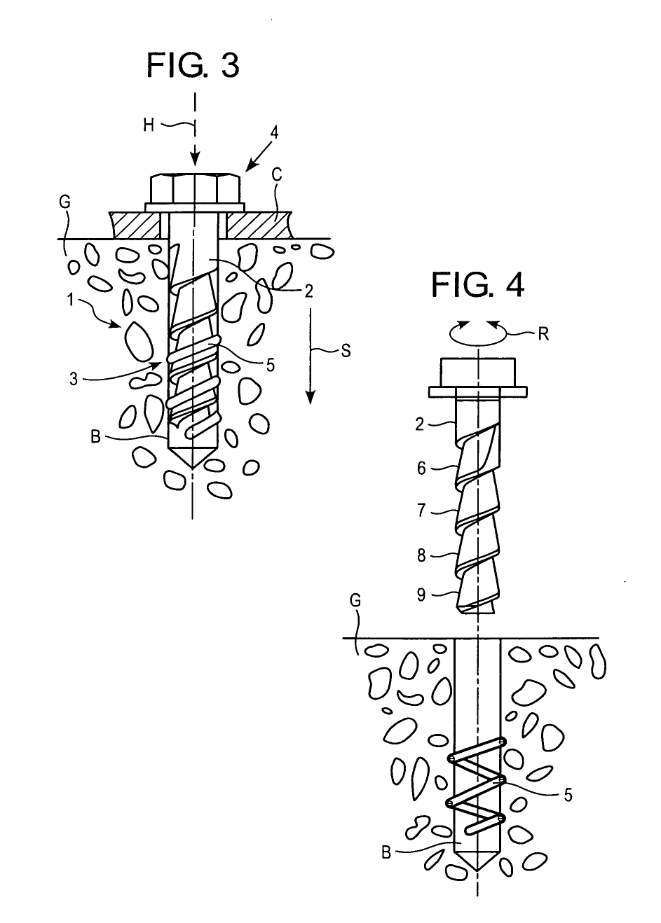

FIG. 3 shows a version of the fastener 1 which has been modified in the head section 4; the fastener is inserted into a receiving hole B in a solid base G, such as for example concrete, stone, solid brick, wood or the like. The hexagon moreover forms the application means for transmission of torque which lies outside in this case.

The arrow H symbolizes that the fastener 1 is driven into the receiving hole B by impact. For example this is done by hammering on the surface of the hexagonal head which is backward on the setting side. In impact installation the helical spring 5 is drawn in length; this results in an increased pitch r of the helical spring and in an increased distance of the adjacent threads. For this reason, the helical spring 5 projects over the outside diameter of the anchoring section 3 (e.g., essentially over its entire length) and leads to positive and nonpositive anchoring of the fastener 1 in the receiving hole B. The support of the helical spring 5 in the end region 11 which is front on the setting side ensures its stretching in hammered installation. Stretching loads the helical spring 5 in tension and in the set state the spring tends to return again to the initial state. In this way the fastener 1 experiences a certain pretensioning which leads to pre-fixing of an attached component C. To adjust the component C the anchor bolt 2 can be screwed slightly out of the helical spring 5 and afterwards tightened to the desired degree. When loaded in tension, the helical spring 5 is further spread due to the cone sections 6-9 which expand in the setting direction. This leads to an increase of the holding values of the fastener 1 which has been placed in the receiving hole B. In a receiving hole which is opening, this effect causes afterexpansion. In this way the fastener 1 can also be used in a tensile zone.

FIG. 4 shows a dismounted fastening point in which the anchor bolt 2 of the fastener 1 is screwed out of the helical spring 5. The direction of rotation is indicated by the double arrow R. The helical spring 5 remains in the receiving hole B. If the fastening point is to be re-used to install a component, the anchor bolt 2 can be easily re-inserted into the receiving hole and screwed into the helical spring 5 which has remained there.

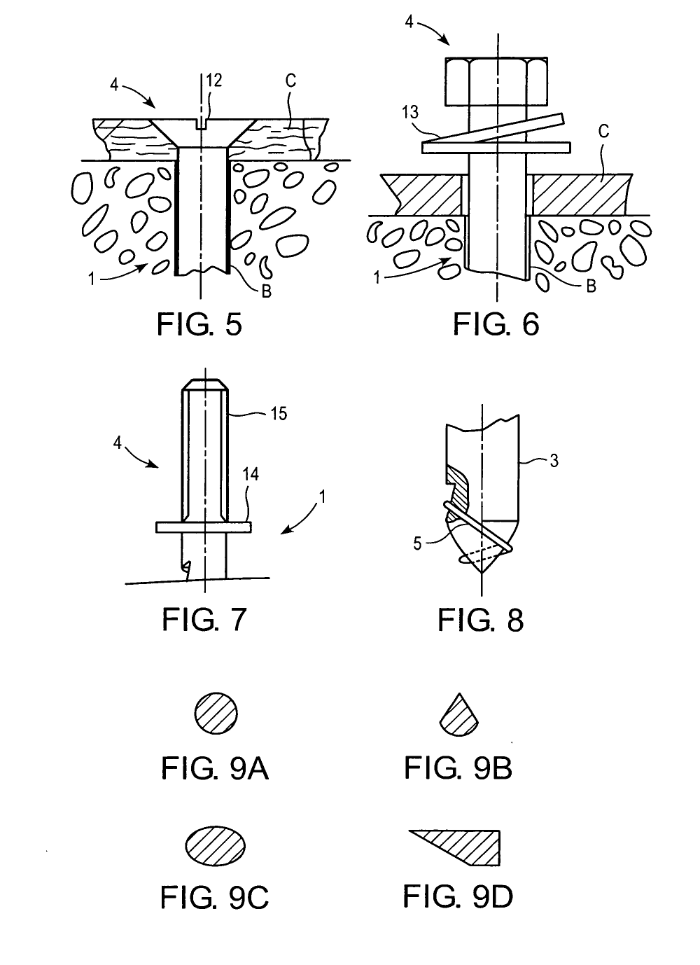

FIG. 5 shows another embodiment of the fastener 1 in which the head section 4 is made as a countersunk head. The head section 4 is in turn provided with an application means 12 for transmission of torque which is made as a diagonally running slot for a screwdriver with a flat blade. FIG. 5 symbolically shows the fastening of a component C, for example wood, which has a certain elasticity. This elasticity of the attached component C supports the pretensioning action of the fastener which has been hammered into the receiving hole B. For the fastener 1 shown in FIG. 6, with a head section 4 which is made in turn as a hexagon, in the case of fastening a rigid component C, such as for example a metal part, this elasticity is ensured by the interposition of an elastic liner part 13, for example a lock washer, a conical spring washer or the like.

FIG. 7 shows another version of the fastener 1 in which the head section 4 has a flange-like widening 14 and a threaded bolt 15 which follows opposite the setting direction. Instead of the flange-like widening, there can also be a hexagonal head joined to the threaded bolt.

FIG. 8 shows one alternative support of the helical spring 5 in the region of the anchoring section 3 which is the front section on the setting side. According to the illustrated embodiment, the anchoring section 3 tapers conically. To fix the helical spring 5, its end region which is the front region on the setting side loops the conical region of the anchoring section 3.

FIGS. 9a-9d show different cross sections of the spring wire from which the helical spring is wound. In addition to a circular cross section (FIG. 9a), the spring wire can also have cross sectional shapes which deviate from the circular shape. This can benefit the attainable holding values.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Fastener for anchoring in a solid base, comprising:
an anchor bolt with an anchoring section which is provided with profiling which runs peripherally in a coil-like manner over at least a partial region of the anchoring section's lengthwise extension;
a head section which adjoins the anchoring section opposite a setting direction and which has been radially expanded relative to the anchoring section; and
a helical spring which can be premounted on the partial region of the anchoring section, wherein the profiling which runs peripherally in the coil-like manner is formed by at least two axially adjoining cone sections with a jacket surface which runs in a coil shape, which sections widen in a setting direction of the anchor bolt, the cone sections having a pitch which is greater than a pitch of the helical spring, and a front end of the helical spring on the setting side being supported on a front end region of the cone section which is exposed on the setting side of the anchor bolt.

2. Fastener as claimed in claim 1, wherein the anchoring section provided with the cone sections has an axial length which is larger than an axial height of the helical spring in a relieved or in a premounted state.

3. Fastener as claimed in claim 1, wherein the front end of the helical spring which is the front end on the setting side is supported on a face surface of the cone section exposed on the setting side.

4. Fastener as claimed in claim 1, wherein a region of the cone sections which has a smallest outside diameter and a material thickness of the helical spring are made such that a sum of the smallest outside diameter and of the material thickness is equal to or slightly greater than a largest outside diameter of the cone sections.

5. Fastener as claimed in claim 1, wherein the jacket surface of the cone sections which runs in a coil shape runs tilted by an angle from 5° to 16° relative to an axis of the anchoring section.

6. Fastener as claimed in claim 5, wherein an jacket surface of the cone sections which runs in a coil shape runs tilted by an angle from roughly 7° to roughly 14° relative to the axis of the anchoring section.

7. Fastener as claimed in claim 5, wherein the angle which is enclosed by the jacket surface of each cone section with the axis of the anchoring section increases opposite the setting direction.

8. Fastener as claimed in claim 7, wherein each cone section is made stepped and the angle which is enclosed by the jacket surface of each cone section with the axis of the anchoring section increases in steps opposite the setting direction.

9. Fastener as claimed in claim 8, wherein each cone section has three steps.

10. Fastener as claimed in claim 5, wherein the angle which is enclosed by the jacket surface of each cone section with the axis of the anchoring section increases continuously opposite the setting direction.

11. Fastener as claimed in claim 1, wherein the anchor bolt consists of metal.

12. Fastener as claimed in claim 1, wherein the head section is radially widened relative to the anchoring section and has the shape of a hexagon.

13. Fastener as claimed in claim 12, wherein opposite the setting direction, the hexagonal head is adjoined by a bolt section with a connecting thread.

14. Fastener as claimed in claim 1, wherein the head section has a shape of a countersunk head or a lens head and is provided with application means for transmission of torque.

15. Fastener as claimed in claim 14, wherein the application means is made as a hexagon socket, a torx receiver or crossed slot receiver, or a diagonally running slot or the like.

16. Fastener as claimed in claim 1, wherein on a transition from the anchoring section to a head section with a larger outside diameter there is an axially elastic liner part.

17. Fastener as claimed in claim 1, wherein the helical spring is wound from a wire of spring steel.

18. Fastener as claimed in claim 1, wherein the helical spring is wound from a profile wire with a nonround cross section.

19. Fastener as claimed in claim 1, wherein the wire of the helical spring is provided with a friction-reducing coating.

20. Fastener as claimed in claim 2, wherein the front end of the helical spring is supported on a face surface of the cone section exposed on the setting side.

21. Fastener as claimed in claim 20, wherein a region of the cone sections which has a smallest outside diameter and a material thickness of the helical spring are made such that a sum of the smallest outside diameter and of the material thickness is equal to or slightly greater than a largest outside diameter of the cone sections.

22. Fastener as claimed in claim 21, wherein the jacket surface of the cone sections which runs in a coil shape runs tilted by an angle from 5° to 16° relative to the axis of the anchoring section.

23. Fastener as claimed in claim 1, wherein the solid base is one of concrete, stone, solid brick, or wood.

24. Fastener as claimed in claim 1, wherein the anchor bolt consists of stainless steel.

25. Fastener as claimed in claim 16, wherein the axially elastic liner part is a lock washer, or a conical spring washer.
